(19) United States
(12) Patent Application Publication
(10) Pub. No.: US 2014/0022979 A1
(43) Pub. Date: Jan. 23, 2014

(54) WIRELESS COMMUNICATION METHOD, RELAY NODE, AND BASE STATION

(71) Applicant: FUJITSU LIMITED, Kawasaki-shi (JP)

(72) Inventors: Hongyang CHEN, Yokosuka (JP); Akira Ito, Yokohama (JP)

(73) Assignee: FUJITSU LIMITED, Kawasaki-shi (JP)

(21) Appl. No.: 13/730,463

(22) Filed: Dec. 28, 2012

(30) Foreign Application Priority Data
Mar. 14, 2012 (JP) 2012-057994

(51) Int. Cl. H04B 7/155

(52) U.S. Cl. CPC H04B 7/15578
USPC 370/315

(57) ABSTRACT

A wireless communication method includes: receiving, at a second apparatus wirelessly connected to a first apparatus, a signal containing a signal from the first apparatus; calculating a receiving weight matrix based on the received signal and a channel matrix that is for communication between the first apparatus and the second apparatus; and multiplying the received signal by the receiving weight matrix.

### CROSS-REFERENCE TO RELATED APPLICATION

This application is based upon and claims the benefit of priority of the prior Japanese Patent Application No. 2012-057994, filed on Mar. 14, 2012, the entire contents of which are incorporated herein by reference.

### FIELD

The embodiments discussed herein are related to a wireless communication method, a relay node, and a base station.

### BACKGROUND

Interference is a major problem affecting the performance of wireless communication systems that include a transmitting apparatus and a receiving apparatus. With Long Term Evolution Advanced (LTE Advanced) systems, relay technology is a promising method for expanding coverage and increasing the communication rate.

Relay technology has been the focus of much attention recently. The usage of relay nodes has been proposed as an alternative method that yields effects equivalent to increasing the number of base stations.

Although a relay node is a transmitting apparatus, a relay node does not have a fixed connection to the core network. A relay node receives and recovers data from a base station (referred to as an eNodeB or eNB), and forwards the data to nearby user equipment (UE) (such as a mobile phone, for example). By suitably placing relay nodes, a relay network has the possibility of surpassing past networks from the perspective of coverage and throughput. Some of the advantages of using relay nodes include coverage areas that are larger than the communication range of each base station, increased throughput to UE, and shadow area coverage.

Individual relay nodes have small coverage areas, and frequencies may be reused among relay nodes. Also, the transmission power and antenna height desired for a relay node may both be less than the transmission power and antenna height desired for an eNB.

3rd Generation Partnership Project (3GPP) LTE-Advanced (LTE-A) has commenced research on development of heterogeneous networks (HetNet) as an effective method of handling increasing communication traffic demands. HetNet is a mixture of macrocells, remote radio heads, and low-power nodes, such as picocells, femtocells, and relay nodes. Utilizing network technology to increase the proximity between access networks and end users has the possibility of improving reuse of the spatial spectrum, strengthening indoor coverage, and providing great strides in performance for wireless networks.

For additional information, see Japanese Unexamined Patent Application Publication No. 2007-181166, Japanese Unexamined Patent Application Publication No. 2009-10968, and Japanese Unexamined Patent Application Publication No. 2007-215008, as well as the following publications:

D. Lopez-Perez, I. Guvenc, G. de la Roche, M. Kountouris, T. Q. S. Quek, and J. Zhang, “Enhanced intercell interference coordination challenges in heterogeneous networks,” IEEE Wireless Communications, vol. 18, no. 3, pp. 22-30, Jun. 2011.

3GPP R1-104661, “Comparison of Time-Domain eICIC Solutions,” Madrid, Spain, August 2010.

3GPP R1-102618, “Considerations on non-CA based heterogeneous deployments,” Montreal, Canada, May, 2010.

3GPP R1-104968, “Summary of the description of candidate eICIC solutions,” Madrid, Spain, August 2010.

L. Fan, K. FUKAWA, H. SUZUKI, and S. SUYAMA, “MAP receiver with spatial filters for suppressing cochannel interference in MIMO-OFDM mobile communications,” IEICE Trans. Comm., vol. E92-B, No. 5, pp. 1841-1851, May 2009.

D. P. Palomar and Y. Jiang, “MIMO transceiver design via majorization theory,” Foundations and Trends in Communications and Information Theory, Vol. 3, No. 4-5, pp. 331-551, now Publishers Inc., MA, USA, 2006.

### SUMMARY

According to an aspect of the invention, a wireless communication method includes: receiving, at a second apparatus wirelessly connected to a first apparatus, a signal containing a signal from the first apparatus; calculating a receiving weight matrix based on the received signal and a channel matrix that is for communication between the first apparatus and the second apparatus; and multiplying the received signal by the receiving weight matrix.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of a system configuration according to a first embodiment;

FIG. 2 illustrates an example of a base station;

FIG. 3 illustrates an example of a relay node;

FIG. 4 illustrates an example of user equipment;

FIG. 5 illustrates an example of a hardware configuration of a base station;

FIG. 6 illustrates an example of a hardware configuration of a relay node;

FIG. 7 illustrates an example of a hardware configuration of user equipment;

FIG. 8 illustrates an example of a system configuration according to a second embodiment;

FIG. 9 illustrates an example of a base station; and

FIG. 10 illustrates an example of a hardware configuration of a base station.

### DESCRIPTION OF EMBODIMENTS

Hereinafter, embodiments will be described with reference to the drawings. The configurations of the embodiments are given by way of example, and a configuration in accordance with the disclosure is not limited to the specific configurations of the embodiments in this disclosure. A specific configuration according to an embodiment may also be suitably implemented when carrying out a configuration in accordance with the disclosure.

Herein, an LTE-A system will be described as an example, but the configurations discussed herein may also be applied to systems other than LTE-A systems.

### First Embodiment

### Configuration Example

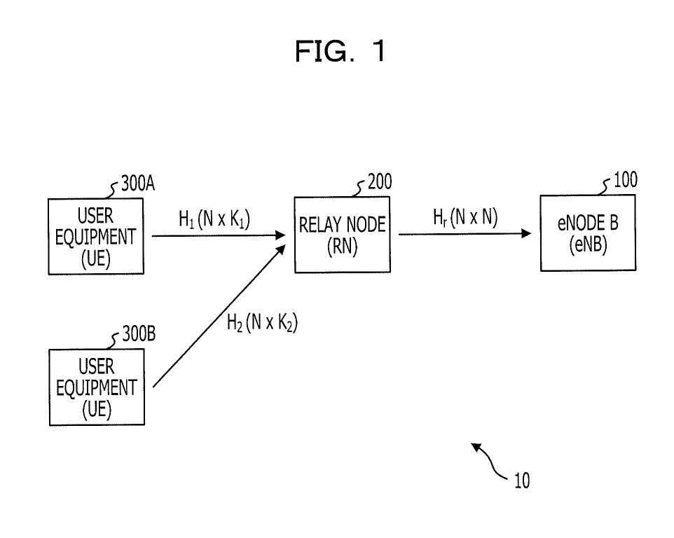

FIG. 1 illustrates an example of a system configuration according to a first embodiment. As illustrated in FIG. 1, a system 10 according to the first embodiment includes a base station (referred to as an eNodeB or eNB) 100, a relay node (RN) 200, user equipment (UE) 300A, and user equipment (UE) 300B. The user equipment 300A is connected to the relay node 200. The user equipment 300B is connected to equipment, such as a base station other than the base station 100 or a relay node other than the relay node 200. The user equipment 300B is not connected to the relay node 200. Herein, we assume that the base station 100 and the relay node 200 are capable of receiving signals transmitted by the user equipment 300B. For the relay node 200, signals transmitted by the user equipment 300B are interference signals. The relay node 200 removes interference signals and noise from a received signal, and extracts a signal from the user equipment 300A. The relay node 200 subjects the signal from the user equipment 300A to given processing, and transmits the processed signal to the base station 100.

The user equipment 300A and the user equipment 300B have similar configurations. Hereinafter, the user equipment 300A and the user equipment 300B may be collectively referred to as the user equipment 300 when not being individually distinguished.

The base station 100 is connected to the relay node 200. The base station 100 communicates with apparatus on a network. For example, a signal transmitted from the user equipment 300A may be forwarded to a desired apparatus via the relay node 200 and the base station 100.

The relay node 200 communicates with the user equipment 300A and the base station 100. The relay node 200 may receive signals from the user equipment 300A and signals from the user equipment 300B. The relay node 200 suppresses signals from the user equipment 300B and noise from a received signal, and transmits the resulting signal to the base station 100.

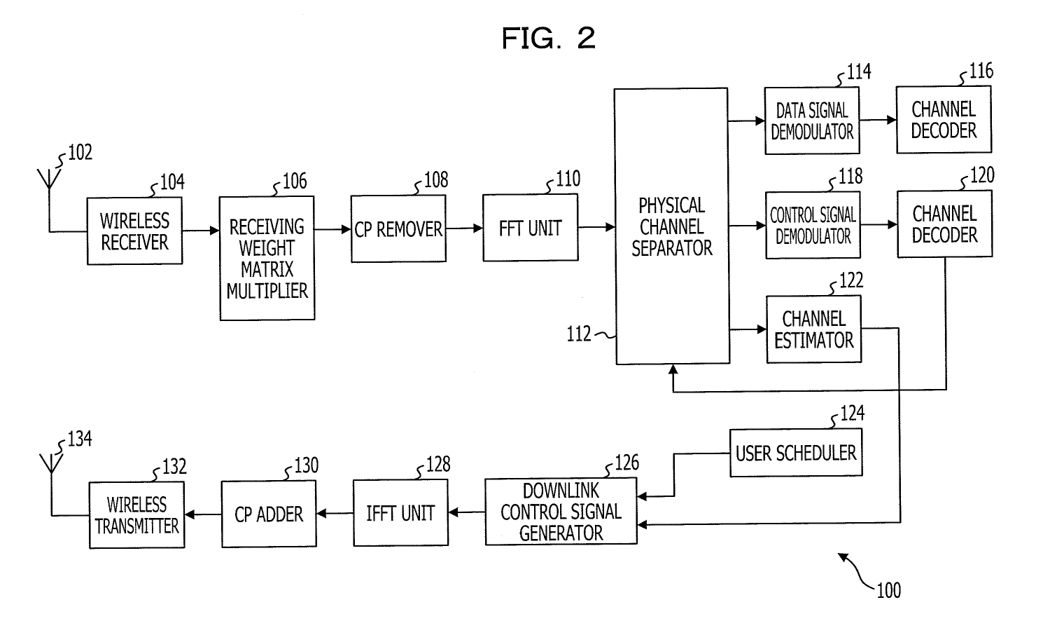

FIG. 2 illustrates an example of a base station. The base station 100 in FIG. 2 includes an uplink receiving antenna 102, a wireless receiver 104, a receiving weight matrix multiplier 106, a cyclic prefix (CP) remover 108, an FFT unit 110, and a physical channel separator 112. The base station 100 also includes a data signal demodulator 114, a channel decoder 116, a control signal demodulator 118, a channel decoder 120, and a channel estimator 122. Additionally, the base station 100 includes a user scheduler 124, a downlink control signal generator 126, an IFFT unit 128, a CP adder 130, a wireless transmitter 132, and a downlink transmitting antenna 134.

The uplink receiving antenna 102 receives signals from apparatuses such as the relay node 200 and the user equipment 300.

The wireless receiver 104 converts a signal received by the uplink receiving antenna 102 into a digital signal.

The receiving weight matrix multiplier 106 multiplies the received signal by a receiving weight matrix.

The CP remover 108 removes CPs from the output of the receiving weight matrix multiplier 106.

The FFT unit 110 applies a fast Fourier transform to the output of the CP remover 108.

The physical channel separator 112 separates the output of the FFT unit 110 into a data signal, a control signal, and a reference signal. The physical channel separator 112 outputs the data signal to the data signal demodulator 114. The physical channel separator 112 outputs the control signal to the control signal demodulator 118. The physical channel separator 112 outputs the reference signal (for example, a pilot signal) to the channel estimator 122.

The data signal demodulator 114 demodulates the data signal. The channel decoder 116 decodes the signal demodulated by the data signal demodulator 114.

The control signal demodulator 118 demodulates the control signal. The channel decoder 120 decodes the signal demodulated by the control signal demodulator 118. The physical channel separator 112 separates signals based on information included in the control signal decoded by the channel decoder 120.

The channel estimator 122 estimates the channel to use between a transmitting apparatus (such as the relay node 200) and the base station 100 based on a reference signal transmitted from the transmitting apparatus. In other words, the channel estimator 122 computes a channel matrix to use for transmissions from the transmitting apparatus to the base station 100.

The user scheduler 124 manages schedules for the channels between the base station 100 and the user equipment 300, channels between the base station 100 and the relay node 200, and channels between the user equipment 300 and the relay node 200. For example, a schedule may be information indicating the allocation of frequency bands and times to be used by wireless signals communicated between the base station 100 and the relay node 200 (such as uplink resource allocation information).

The downlink control signal generator 126 generates a downlink control signal based on both channel schedule information acquired from the user scheduler 124 as well as channel estimation information from the channel estimator 122.

The IFFT unit 128 applies an inverse fast Fourier transform to the output of the downlink control signal generator 126.

The CP adder 130 adds a CP to the output of the IFFT unit 128.

The wireless transmitter 132 converts the output of the CP adder 130 into an analog signal, and outputs the analog signal to the downlink transmitting antenna 134.

The downlink transmitting antenna 134 transmits a wireless signal to a receiving apparatus (such as a relay node or user equipment).

The uplink receiving antenna 102 and the downlink transmitting antenna 134 may be a shared antenna.

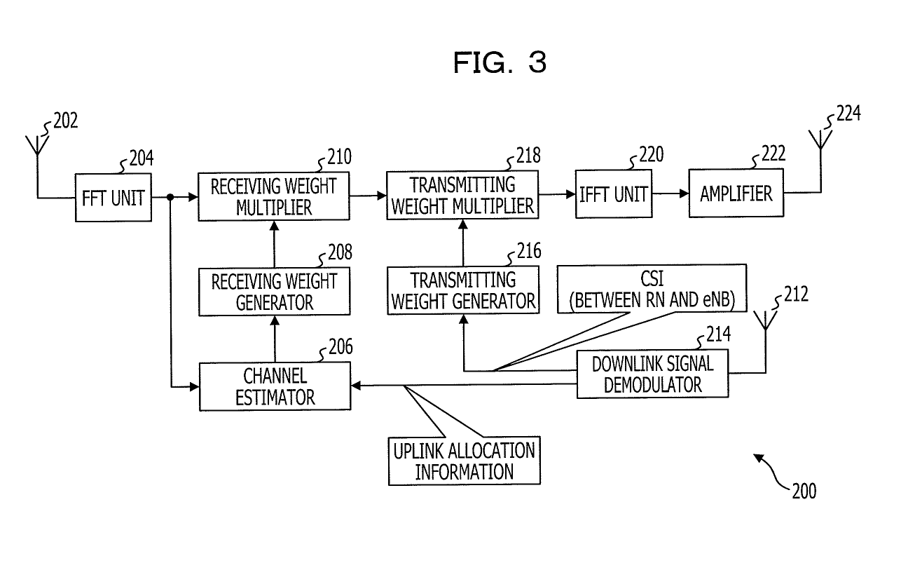

FIG. 3 illustrates an example of a relay node. The relay node 200 in FIG. 3 includes an uplink receiving antenna 202, an FFT unit 204, a channel estimator 206, a receiving weight generator 208, and a receiving weight multiplier 210. The relay node 200 also includes a downlink receiving antenna 212, a downlink signal demodulator 214, a transmitting weight generator 216, a transmitting weight multiplier 218, an IFFT unit 220, an amplifier 222, and an uplink transmitting antenna 224.

The uplink receiving antenna 202 receives signals from the user equipment 300. The uplink receiving antenna 202 may also be a collection of a plurality of antennas.

The FFT unit 204 converts a signal received by the uplink receiving antenna 202 into a digital signal and applies a fast Fourier transform.

The channel estimator 206 estimates the channel between the user equipment 300A and the relay node 200 based on information such as a reference signal (for example, a pilot signal) transmitted from the user equipment 300A and uplink allocation information input from the downlink signal demodulator 214. In other words, the channel estimator 206 computes a channel matrix for use with transmission from the user equipment 300A to the relay node 200.

The receiving weight generator 208 generates a receiving weight matrix based on the received signal and the channel matrix for use with transmission from the user equipment 300A to the relay node 200. The receiving weight matrix is a matrix for suppressing signals such as signals other than the signal from the user equipment 300A.

The receiving weight multiplier 210 multiplies the received signal, which was subjected to a fast Fourier transform by the FFT unit 204, by the receiving weight matrix that was generated by the receiving weight generator 208, and computes the signal from the user equipment 300A with interference removed.

The downlink receiving antenna 212 receives signals from the base station 100. The downlink receiving antenna 212 may also be a collection of a plurality of antennas.

The downlink signal demodulator 214 demodulates a signal from the base station 100 that is received by the downlink receiving antenna 212. A signal from the base station 100 includes information such as uplink allocation information and channel state information (CSI). Uplink allocation information includes allocation information for the upstream communication link between the user equipment 300A and the relay node 200. CSI is information on the state of the channels between the relay node 200 and the base station 100. The downlink signal demodulator 214 outputs the uplink allocation information (uplink resource allocation information) to the channel estimator 206, and outputs the CSI or other information about the channels between the relay node 200 and the base station 100 to the transmitting weight generator 216.

The transmitting weight generator 216 generates a transmitting weight matrix based on factors such as the CSI that are input from the downlink signal demodulator 214.

The transmitting weight multiplier 218 multiplies the signal output from the receiving weight multiplier 210 by the transmitting weight matrix generated by the transmitting weight generator 216.

The receiving weight generator 208 and the transmitting weight generator 216 may also be unified and operate as a weight generator. Likewise, the receiving weight multiplier 210 and the transmitting weight multiplier 218 may also be unified and operate as a weight multiplier.

The IFFT unit 220 applies an inverse fast Fourier transform to the signal input from the transmitting weight multiplier 218. The IFFT unit 220 also converts the digital signal that was subjected to the inverse fast Fourier transform into an analog signal.

The amplifier 222 amplifies the signal that was subjected to the inverse fast Fourier transform by the IFFT unit 220, and outputs the amplified signal to the uplink transmitting antenna 224.

The uplink transmitting antenna 224 transmits the signal to the base station 100. The uplink transmitting antenna 224 may also be a collection of a plurality of antennas.

The uplink receiving antenna 202, the downlink receiving antenna 212, and the uplink transmitting antenna 224 may also be a shared antenna.

Although it is assumed herein that a single user equipment 300A is connected to the relay node 200, a plurality of user equipment may be connected to the relay node 200. When a plurality of user equipment connect to the relay node 200, a channel matrix is computed for each piece of user equipment, a receiving weight matrix is computed for each piece of user equipment, and the signal from each piece of user equipment are computed.

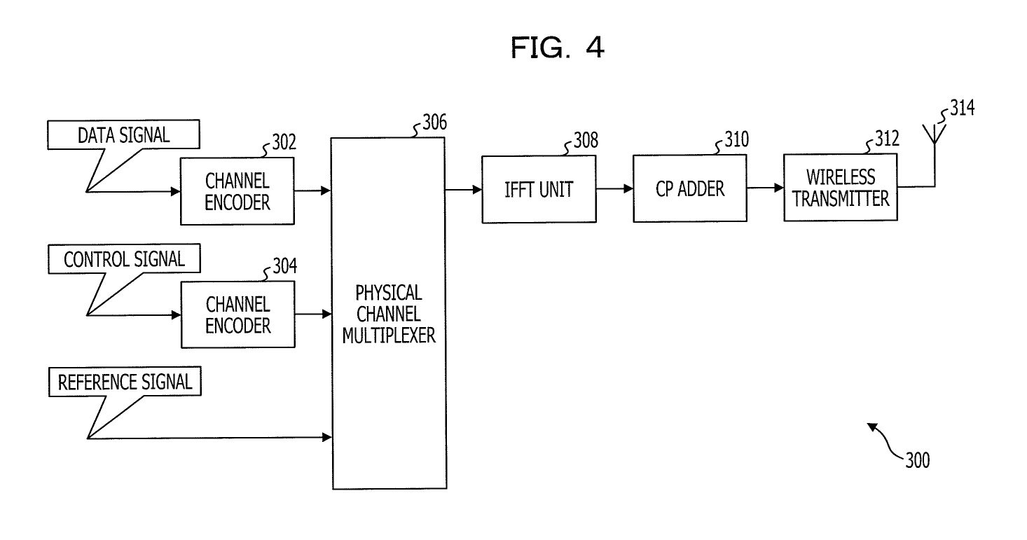

FIG. 4 illustrates an example of user equipment. The user equipment 300 in FIG. 4 includes a channel encoder 302, a channel encoder 304, a physical channel multiplexer 306, an IFFT unit 308, a CP adder 310, a wireless transmitter 312, and an uplink transmitting antenna 314.

The channel encoder 302 subjects an input data signal to channel encoding.

The channel encoder 304 subjects an input control signal to channel encoding.

The physical channel multiplexer 306 multiplexes a channel-encoded data signal, a channel-encoded control signal, and a reference signal.

The IFFT unit 308 applies an inverse fast Fourier transform to the signal multiplexed by the physical channel multiplexer 306.

The CP adder 310 adds a CP to the output of the IFFT unit 308.

The wireless transmitter 312 converts the output of the CP adder 310 into an analog signal, and outputs the analog signal to the uplink transmitting antenna 314.

The uplink transmitting antenna 314 transmits a wireless signal to a receiving apparatus (such as a relay node or a base station).

Each apparatus has two or more antennas.

The base station 100 and the relay node 200 are realizable using special-purpose or general-purpose computers, or electronic devices equipped with computers. The user equipment 300 are realizable using special-purpose or general-purpose computers such as smartphones, mobile phones, or car navigation systems, or electronic devices equipped with computers.

A computer, or in other words an information processing apparatus, includes a processor, a primary storage device, and an auxiliary storage device, as well as a communication interface or other interfaces that interface with peripheral devices. A storage device (primary storage device and auxiliary storage device) is computer-readable recording media.

The computer is able to realize functions consistent with a given objective as a result of the processor loading a program stored in a recording medium into a work area of the primary storage device and executing the program, so that one or more peripheral devices are controlled via the execution of the program.

The processor may be a central processing unit (CPU) or a digital signal processor (DSP), for example. The primary storage device may include random access memory (RAM) and read-only memory (ROM), for example.

The auxiliary storage device may be erasable programmable ROM (EPROM) or a hard disk drive (HDD), for example. The auxiliary storage device may also include removable media, or in other words, portable recording media. The removable media may be Universal Serial Bus (USB) memory, or disc recording media such as a Compact Disc (CD) or a Digital Versatile Disc (DVDs), for example.

The communication interface may be a local area network (LAN) interface board or a wireless communication link for wireless communication, for example.

Besides the above-described auxiliary storage device and communication interface, peripheral devices may include input devices such as a keyboard or a pointing device, and output devices such as a display or a printer. In addition, the input devices may also include a video or image input device such as a camera, and an audio input device such as a microphone. The output devices may also include an audio output device such as a speaker.

A series of processing operations may be executed in hardware, but may be executed in software.

The steps describing the program encompass processing operations conducted in a time series following the stated order, but also encompass operations that are executed, either in parallel or individually, without strictly being processed in a time series.

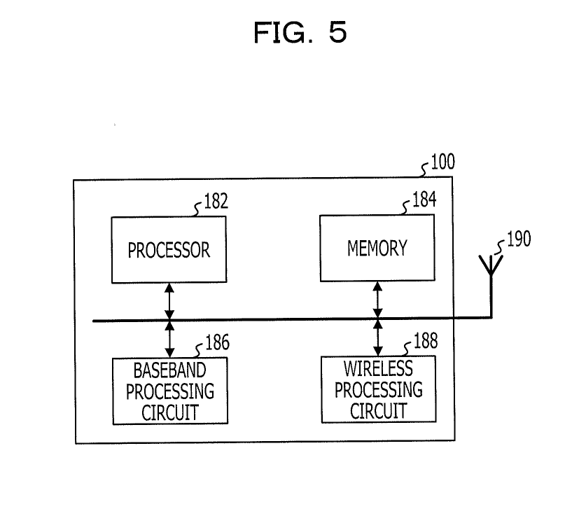

FIG. 5 illustrates an example of a hardware configuration of a base station. The base station 100 includes a processor 182, a storage device 184, a baseband processing circuit 186, a wireless processing circuit 188, and an antenna 190. The processor 182, the storage device 184, the baseband processing circuit 186, the wireless processing circuit 188, and the antenna 190 are connected to each other via a bus, for example.

The processor 182 may realize the functions of the receiving weight matrix multiplier 106, the channel decoder 116, the channel decoder 120, the channel estimator 122, and the user scheduler 124.

The storage device 184 stores information such as programs executed by the processor 182, and data used during the execution of the programs.

The baseband processing circuit 186 may realize the functions of the CP remover 108, the FFT unit 110, the physical channel separator 112, the data signal demodulator 114, the downlink control signal generator 126, the IFFT unit 128, and the CP adder 130. The baseband processing circuit 186 processes baseband signals.

The wireless processing circuit 188 may realize the functions of the wireless receiver 104 and the wireless transmitter 132. The wireless processing circuit 188 processes wireless signals transmitted or received by the antenna 190.

The antenna 190 may realize the functions of the uplink receiving antenna 102 and the downlink transmitting antenna 134.

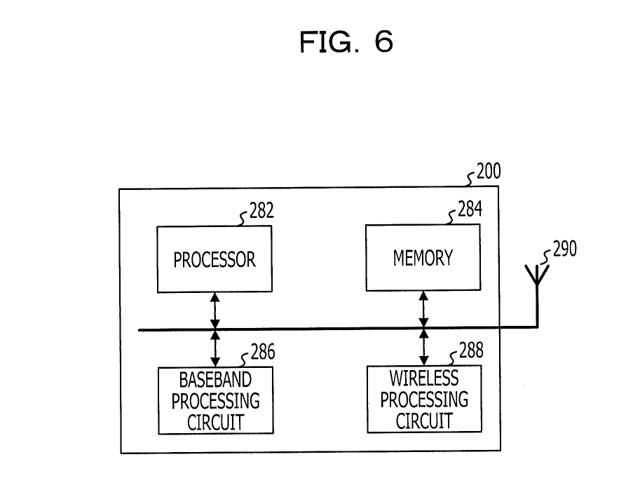

FIG. 6 illustrates an example of a hardware configuration of a relay node. The relay node 200 includes a processor 282, storage device 284, a baseband processing circuit 286, a wireless processing circuit 288, and an antenna 290. The processor 282, the storage device 284, the baseband processing circuit 286, the wireless processing circuit 288, and the antenna 290 are connected to each other via a bus, for example.

The processor 282 may realize the functions of the channel estimator 206, the receiving weight generator 208, the receiving weight multiplier 210, the transmitting weight generator 216, and the transmitting weight multiplier 218.

The storage device 284 stores information such as programs executed by the processor 282, and data used during the execution of the programs.

The baseband processing circuit 286 may realize the functions of the FFT unit 204 and the IFFT unit 220. The baseband processing circuit 286 processes baseband signals.

The wireless processing circuit 288 may realize the functions of the amplifier 222. The wireless processing circuit 288 processes wireless signals transmitted or received by the antenna 290.

The antenna 290 may realize the functions of the uplink receiving antenna 202 and the uplink transmitting antenna 224.

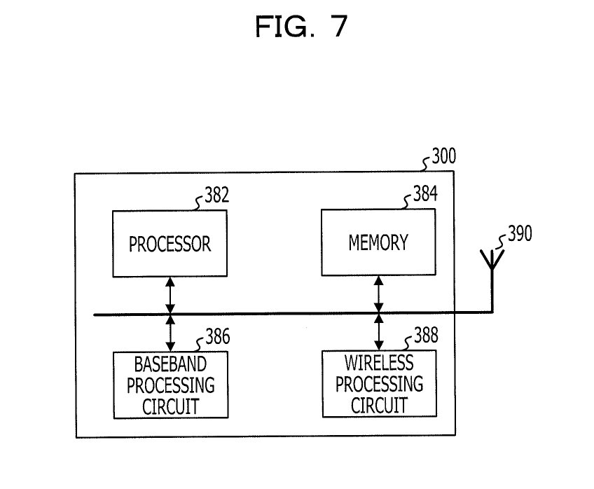

FIG. 7 illustrates an example of a hardware configuration of user equipment. The user equipment 300 includes a processor 382, storage device 384, a baseband processing circuit 386, a wireless processing circuit 388, and an antenna 390. The processor 382, the storage device 384, the baseband processing circuit 386, the wireless processing circuit 388, and the antenna 390 are connected to each other via a bus, for example.

The processor 382 may realize the functions of the channel encoder 302 and the channel encoder 304.

The storage device 384 stores information such as programs executed by the processor 382, and data used during the execution of the programs.

The baseband processing circuit 386 may realize the functions of the physical channel multiplexer 306, the IFFT unit 308, and the CP adder 310. The baseband processing circuit 386 processes baseband signals.

The wireless processing circuit 388 may realize the functions of the wireless transmitter 312. The wireless processing circuit 388 processes wireless signals transmitted and received by the antenna 390.

The antenna 390 may realize the functions of the uplink transmitting antenna 314.

(Computing Weights)

A method of computing weight matrices (the receiving weight matrix and the transmitting weight matrix) in the relay node 200 will now be described. Weight matrices are computed by the receiving weight generator 208 and the transmitting weight generator 216.

We assume that the base station 100 has M uplink receiving antennas. The relay node 200 is assumed to have N uplink receiving antennas and N uplink transmitting antennas. The user equipment 300A is assumed to have K₁ uplink transmitting antennas. The user equipment 300B is assumed to have K₂ uplink transmitting antennas.

In an LTE-A system, the user equipment 300 transmits orthogonal frequency-division multiplexing (OFDM) symbols. For simplicity, symbols on one subcarrier (such as BPSK or QPSK) will be considered herein.

The user equipment 300A has K₁ symbols (data streams) mapped to K₁ antennas. The user equipment 300B has K₂ symbols mapped to K₂ antennas. Higher layers are able to inform the user equipment 300 of the number of data streams. Although the number of antennas and the number of data streams are taken to be equal herein, the number of data streams may also be less than the number of antennas. In this case, K₁ and K₂, which will be used in later calculations, represent the number of data streams in the user equipment 300A and the user equipment 300B, respectively.

Taking s₁ and s₂ to be respective signals transmitted from the user equipment 300A and the user equipment 300B, the signal s₁ and the signal s₂ are expressed as follows in Eq. (1).

sᵢ=(Sᵢ₁,Sᵢ₂, . . . ,S_{iKi})^{T} (i=1,2) (1)

Herein, Sᵢ₁ to S_{iKi} are BPSK symbols or QPSK symbols, for example. Also, S₁ⱼ is the signal transmitted from the jth antenna of the user equipment 300A, while S₂ₖ is the signal transmitted from the kth antenna of the user equipment 300B, for example.

The relay node 200 receives signals from sources such as the user equipment 300A and the user equipment 300B. The received signal rᵣ at the relay node 200 is expressed in Eq. (2) as follows. Note that the received signal rᵣ is a vector with N rows and 1 column (N×1), where N is the number of antennas in the relay node 200.

rᵣ=H₁s₁+H₂s₂+nᵣ (2)

Herein, take H₁ to be the channel matrix for transmission from the user equipment 300A to the relay node 200, and take H₂ to be the channel matrix for transmission from the user equipment 300B to the relay node 200. H₁ and H₂ are N×K₁ and N×K₂ matrices, respectively. For example, in H₁, the i×j component is the propagation coefficient from the jth antenna of the user equipment 300A to the ith antenna of the relay node 200. In addition, nᵣ is the noise at the relay node 200. For example, H₁ is obtained based on the user equipment 300A transmitting a reference signal (such as a pilot signal) to the relay node 200, as well as channel allocation information.

The equalized signal yᵣ from the uplink transmitting antenna 314 of the user equipment 300A at the relay node 200 is expressed in Eq. (3) as follows, with yᵣ being a K₁×1 vector.

yᵣ=W_{Rr}rᵣ=W_{Rr}(H₁s₁+H₂s₂+nᵣ) (3)

Herein, W_{Rr} is the receiving weight matrix. The receiving weight matrix W_{Rr} is a matrix with K₁ rows and N columns (K₁×N).

The equalized signal yᵣ is mapped to the uplink transmitting antenna 224 of the relay node 200 by the transmitting weight matrix W_{Rt}. The signal transmitted from the relay node 200 to the base station 100 (relay transmit signal) xᵣ is expressed in Eq. (4) as follows.

xᵣ=W_{Rt}yᵣ=W_{Rt}W_{Rr}rᵣ (4)

Herein, W_{Rt} is the transmitting weight matrix. The transmitting weight matrix W_{Rt} is a matrix with N rows and K₁. columns (N×K₁). The term xᵣ is an N×1 vector, where N is the number of uplink transmitting antennas 224 in the relay node 200.

The base station 100 receives signals from sources such as the relay node 200 and the user equipment 300B. A received signal r_{d} at the base station 100 is expressed in Eq. (5) as follows.

r_{d}=Hᵣxᵣ+n_{d}=HᵣW_{Rt}W_{Rr}rᵣ+n_{d} (5)

Herein, take Hᵣ to be the channel matrix for transmission from the relay node 200 to the base station 100, with n_{d} being the noise at the base station 100. The channel matrix Hᵣ is an M×N matrix.

The equalized signal y_{d} from the uplink transmitting antenna 314 of the user equipment 300A at the base station 100 is expressed in Eq. (6) as follows, with y_{d} being a K₁×1 vector.

$$\begin{matrix}{y}_{d} = {W}_{d} {r}_{d} \\ = {W}_{d} {H}_{r} {W}_{Rt} {W}_{Rr} {r}_{r} + {W}_{d} {n}_{d} \\ = {W}_{d} {H}_{r} {W}_{Rt} {W}_{Rr} ( {H}_{1} {s}_{1} + {H}_{2} {s}_{2} + {n}_{r} ) + {W}_{d} {n}_{d} \\ = {W}_{d} {H}_{r} {W}_{Rt} {W}_{Rr} {H}_{1} {s}_{1} + {W}_{d} {H}_{r} {W}_{Rt} {W}_{Rr} {H}_{2} {s}_{2} + \\ {W}_{d} {H}_{r} {W}_{Rt} {W}_{Rr} {n}_{r} + {W}_{d} {n}_{d}\end{matrix} \qquad ( 6 )$$

Herein, W_{d} is the receiving weight matrix at the base station 100. The receiving weight matrix W_{d} is a matrix with K₁ rows and M columns (K₁×M).

Interference and noise at the relay node 200 are suppressed by the weight matrix, and noise at the base station 100 is removed.

The receiving weight matrix W_{Rr} at the relay node 200 is designed to suppress interference from the user equipment 300B.

Since the null space of H₂H₂″ is orthogonal to its signal space, the receiving weight matrix W_{Rr} in the relay node 200 is selected as the null space of the space complemented by interference and noise. The receiving weight matrix W_{Rr} is the transpose of K₁ eigenvectors corresponding to the first K₁ eigenvalues in order of ascending value from the eigenvalues of the covariance matrix of the interference channel, and is expressed in Eq. (7) as follows.

$$\begin{matrix}{W}_{Rr}^{T} = {v}_{min K 1} [ E \{ ( {H}_{2} {s}_{2} + {n}_{r} ) {( {H}_{2} {s}_{2} + {n}_{r} )}^{H} \} ] \\ = {v}_{min K 1} [ E \{ ( {H}_{2} {H}_{2}^{H} + {σ}_{r}^{2} {I}_{N} \} ]\end{matrix} \qquad ( 7 )$$

Herein, σᵣ is the noise variance. The noise variance is, for example, the variance of a pilot signal received by the relay node 200. The noise may also be noise within the relay node 200. The term I_{N} is a unit matrix. The notation E used with curly brackets represents ensemble averaging. The notation v_{min K1} used with square brackets represents the K₁ eigenvectors corresponding to the K₁ minimum eigenvalues (the first to K₁th eigenvalues in order of ascending value). For example, v_{min K1}[A] represents the (collection of) eigenvectors corresponding to the K₁ eigenvalues extracted from the eigenvalues of the matrix A in order of ascending value. The term H₂H₂^{H} is the covariance matrix of the interference channel corresponding to an interference signal.

The eigendecomposition is expressed in Eq. (8) as follows.

H₂H₂^{H}+πᵣ²I_{N}=QΛQ^{H} (8)

Herein, Λ is an eigenvalue matrix expressed by the eigenvalues expressed in Eq. (9) as follows.

Λ=diag(λ₁,λ₂, . . . , λ_{N}) (λ₁≦λ₂λ . . . ≦λ_{N}) (9)

Also, Q is an eigenvector matrix expressed in Eq. (10) as follows.

Q=[q₁,q₂, . . . , q_{N}] (10)

Thus, the receiving weight matrix is expressed in Eq. (11) as follows. By using eigenvalues with small values, interference may be suppressed.

W_{Rr}^{T}=v_{min K1}[E{(H₂H₂^{H}+σᵣ²I_{N}}]=[q₁,q₂, . . . , q_{K1}] (11)

However, it may not be practical for the relay node 200 to recognize the channel for an uplink transmission from interfering user equipment 300. Ordinarily, the relay node 200 does not receive a pilot signal from interfering user equipment 300. In other words, it may be difficult for the relay node 200 to obtain H₂, the channel matrix for transmission from the user equipment 300B to the relay node 200.

On the other hand, by using a channel estimation method, the relay node 200 is able to recognize the channels from given user equipment 300 to the relay node 200 according to reference signals (such as pilot signals) transmitted from the given user equipment 300. In other words, it is easy for the relay node 200 to obtain H₁, the channel matrix for transmission from the user equipment 300A to the relay node 200. Then, a new vector z is introduced as follows.

z=rᵣ−H₁s₁=H₂s₂+nᵣ (12)

Eq. (7) may now be expressed in Eq. (13) as follows.

E{(H₂H₂^{H}+σᵣ²I_{N}}=E{zz^{H}}=E{(rᵣ−H₁s₁)(rᵣ−H₁s₁)^{H}} (13)

Herein, zz^{H} is the covariance matrix of the vector z. The term rᵣ is the received signal at the relay node 200, H₁ is the channel matrix for communication between the user equipment 300A and the relay node 200, and s₁ is obtained from a reference signal (such as a pilot signal) from the user equipment 300A. Hence, z=rᵣ−H₁s₁ is easily obtained. In other words, Eq. 13 may be evaluated without calculating H₂, the channel matrix between the user equipment 300B and the relay node 200.

Interference from the user equipment 300B is suppressed while the channel between the relay node 200 and the base station 100 is orthogonalized. However, the separate data streams are coupled to each other due to being transmitted from the user equipment 300A to the relay node 200. A new receiving weight matrix that is orthogonal to a desired data stream while maintaining orthogonality with the user equipment 300B is computed.

All linear combinations of the columns of W_{Rr}^{T} are orthogonal to H₂H₂^{H} (herein assuming that W_{Rr}^{T}=W_{⊥}^{T}). If a coefficient matrix C is introduced, the new receiving weight matrix at the relay node 200 is expressed in Eq. (14) as follows.

\tilde{W}_{Rr}=CW_{⊥}=CW_{Rr} (14)

It is desirable to select a coefficient matrix C so that interference in the data stream from the user equipment 300A is removed at the user equipment 300A after filtering with the new receiving weight matrix. In other words, the new receiving weight matrix satisfies the following formula (15).

\tilde{W}_{Rr}H₁=CW_{⊥}H₁=I_{K}_{₁} [symbol] C=(W_{⊥}H₁)⁻¹ (15)

Thus, the new receiving weight matrix at the relay node 200 may be obtained in Eq. (16) as follows.

\tilde{W}_{Rr}=(W_{⊥}H₁)⁻¹W_{⊥} (16)

The singular value decomposition of the channel matrix Hᵣ between the relay node 200 and the base station 100 is expressed in Eq. (17) as follows.

Hᵣ=UDV^{H} (17)

The term U (M×M) is the left singular matrix, V (N×N) is the right singular matrix, and D (M×N) is the diagonal matrix of singular values. The transmitting weight matrix W_{Rt} at the relay node 200 is a matrix of K₁ vectors from the matrix V that correspond to the first K₁ singular values in order of descending value. The receiving weight matrix W_{d} at the base station 100 is the Hermitian transpose of a matrix of K₁ vectors from the matrix U that correspond to the first K₁ singular values in order of descending value. In doing so, the best K₁ channels from Hᵣ may be used. Thus, the weight matrix W_{R} at the relay node 200 is computed as follows.

W_{R}=W_{Rt}\tilde{W}_{Rr} (18)

By selecting vectors in order of descending value in the singular value decomposition, a desired signal may be more reliably received at the base station 100.

### Action and Advantages of First Embodiment

When user equipment 300A belonging to the relay node 200 and user equipment 300B not belonging to the relay node 200 are present, the relay node 200 generates a weight matrix in order to suppress interference from the user equipment 300B. Multiplexed data streams from the user equipment 300A are made parallel by eigen-beamforming at both the relay node 200 and a base station 100, thus improving the multiplexing gain. The base station 100 allocates uplink resources to the user equipment 300A, and issues the relevant allocation information to the relay node 200. The relay node 200 computes a channel matrix between the user equipment 300A and the relay node 200 based on the allocation information and a reference signal. In addition, the relay node 200 computes a receiving weight matrix for connected user equipment 300 (such as the user equipment 300A) based on factors such as the channel matrix between the user equipment 300A and the relay node 200, and received signals. By predicting signals from the user equipment 300A and the user equipment 300B, the relay node 200 suppresses interference from sources such as the user equipment 300B. The receiving weight matrix at the relay node 200 contains eigenvectors that correspond to the first K₁ eigenvalues in order of ascending value.

The relay node 200 is able to suppress interference due to signals from sources such as the user equipment 300B without using channel information (a channel matrix) between the relay node 200 and the user equipment 300B.

By aligning interference with the null space of the receiving weight matrix, interference from user equipment 300 not belonging to the relay node 200 is suppressed. The receiving weight matrix contains K₁ eigenvectors that correspond to the K₁ eigenvalues in order of ascending value.

The relay node 200 is able to compute a receiving weight matrix that suppresses interference without using information such as channel state information (CSI) for interfering channels.

### Second Embodiment

Next, a second embodiment will be described. The second embodiment has commonalities with the first embodiment. Consequently, the differences will be primarily described, whereas the description of commonalities will be reduced or omitted.

Herein, a MIMO-OFDM system will be described as an example, but the configurations discussed herein may also be applied to systems other than MIMO-OFDM systems.

### Configuration Example

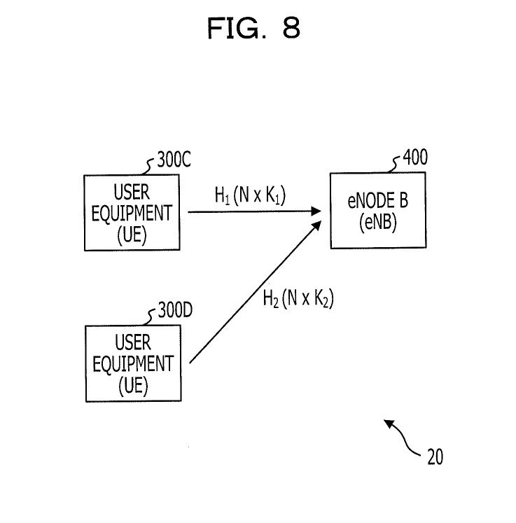

FIG. 8 illustrates an example of a system configuration according to the second embodiment. As illustrated in FIG. 8, a system 20 according to the second embodiment includes a base station (referred to as an eNodeB or eNB) 400, user equipment (UE) 300C, and user equipment (UE) 300D. The user equipment 300C is connected to the base station 400. The user equipment 300D is not connected to the base station 400. Herein, we assume that the base station 400 is capable of receiving a signal transmitted by the user equipment 300D. For the base station 400, a signal transmitted by the user equipment 300D is an interference signal. The base station 400 removes interference signals and noise from a received signal, and decodes a signal from the user equipment 300C.

The user equipment 300C and the user equipment 300D are configured similarly to the user equipment 300 of the first embodiment. Hereinafter, the user equipment 300C and the user equipment 300D may be collectively referred to as the user equipment 300 when not being individually distinguished.

The base station 400 is connected to the user equipment 300C. The base station 400 also communicates with apparatuses on a network. For example, a signal transmitted from the user equipment 300C may be forwarded to a desired apparatus via the base station 400.

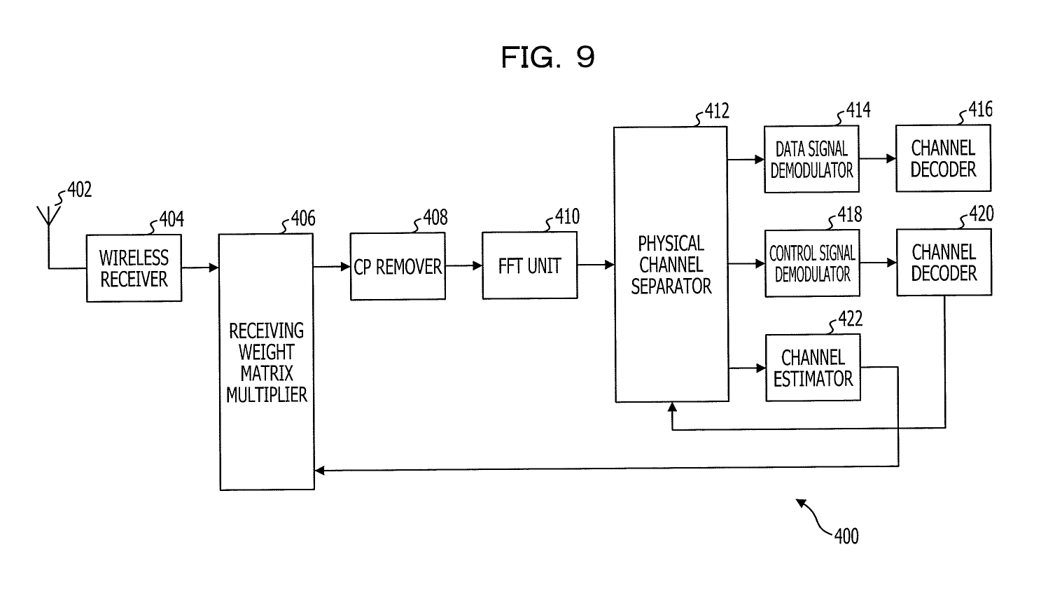

FIG. 9 illustrates an example of a base station. The base station 400 in FIG. 9 includes an uplink receiving antenna 402, a wireless receiver 404, a receiving weight matrix multiplier 406, a CP remover 408, an FFT unit 410, and a physical channel separator 412. The base station 400 also includes a data signal demodulator 414, a channel decoder 416, a control signal demodulator 418, a channel decoder 420, and a channel estimator 422.

The uplink receiving antenna 402 receives signals from sources such as the user equipment 300.

The wireless receiver 404 converts a signal received by the uplink receiving antenna 402 into a digital signal.

The receiving weight matrix multiplier 406 generates a receiving weight matrix, and multiplies the received signal by the receiving weight matrix. The receiving weight matrix is computed similarly to the receiving weight matrix at the relay node 200 in the first embodiment. The receiving weight matrix multiplier 406 may also be divided into a receiving weight generator that computes a receiving weight matrix, and a receiving weight multiplier that multiplies the received signal by the receiving weight matrix.

The CP remover 408 removes CPs from the output of the receiving weight matrix multiplier 406.

The FFT unit 410 applies a fast Fourier transform to the output of the CP remover 408.

The physical channel separator 412 separates the output of the FFT unit 410 into a data signal, a control signal, and a reference signal. The physical channel separator 412 outputs the data signal to the data signal demodulator 414. The physical channel separator 412 outputs the control signal to the control signal demodulator 418. The physical channel separator 412 outputs the reference signal (for example, a pilot signal) to the channel estimator 422.

The data signal demodulator 414 demodulates the data signal. The channel decoder 416 decodes the signal demodulated by the data signal demodulator 414.

The control signal demodulator 418 demodulates the control signal. The channel decoder 420 decodes the signal demodulated by the control signal demodulator 418. The physical channel separator 412 separates signals based on information contained in the control signal decoded by the channel decoder 420.

The channel estimator 422 estimates the channel used for communication between a transmitting apparatus (such as the user equipment 300) and the base station 400 based on a reference signal (such as a pilot signal) transmitted from the transmitting apparatus. In other words, the channel estimator 422 computes a channel matrix for transmission from the transmitting apparatus to the base station 400.

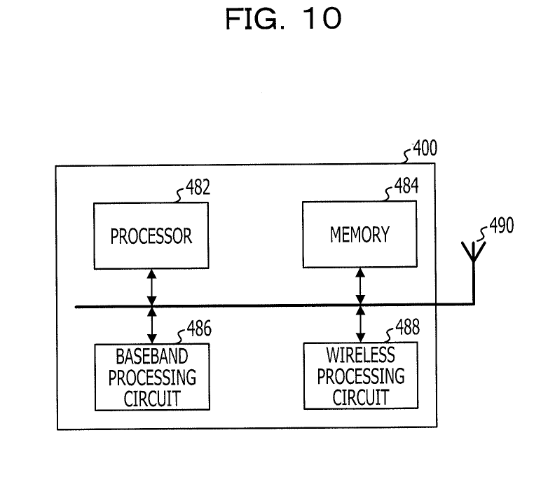

FIG. 10 illustrates an example of a hardware configuration of a base station. The base station 400 includes a processor 482, storage device 484, a baseband processing circuit 486, a wireless processing circuit 488, and an antenna 490. The processor 482, the storage device 484, the baseband processing circuit 486, the wireless processing circuit 488, and the antenna 490 are connected to each other via a bus, for example.

The processor 482 may realize the functions of the receiving weight matrix multiplier 406, the channel decoder 416, the channel decoder 420, and the channel estimator 422.

The storage device 484 stores information such as programs executed by the processor 482, and data used during the execution of the programs.

The baseband processing circuit 486 may realize the functions of the CP remover 408, the FFT unit 410, the physical channel separator 412, and the data signal demodulator 414. The baseband processing circuit 486 processes baseband signals.

The wireless processing circuit 488 may realize the functions of the wireless receiver 404. The wireless processing circuit 488 processes wireless signals transmitted and received by the antenna 490.

The antenna 490 may realize the functions of the uplink receiving antenna 402.

(Computing a Weight Matrix)

The receiving weight matrix multiplier 406 of the base station 400 generates a receiving weight matrix based on the received signal and the channel matrix for transmission from the user equipment 300C to the base station 400. Channel information for the channel between the user equipment 300C and the base station 400 is obtained by the channel estimator 422.

The receiving weight matrix multiplier 406 of the base station 400 generates a receiving weight matrix similarly to the receiving weight generator 208 of the relay node 200 in first embodiment.

In a MIMO-OFDM system, channels depend on frequency. Thus, the receiving weight matrix depends on the subcarrier frequency. A receiving channel matrix may also be computed for each subchannel frequency.

### Action and Advantages of Second Embodiment

The base station 400 computes a receiving weight matrix based on the received signal and channel information on the channel between the user equipment 300C and the base station 400. The base station 400 suppresses interference from sources such as the user equipment 300D by using the computed receiving weight matrix. The base station 400 is able to suppress interference due to signals from sources such as the user equipment 300D without using channel information for the channel between the base station 400 and the user equipment 300D.

The foregoing embodiments may also be carried out in combination insofar as possible.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A wireless communication method comprising:
receiving, at a second apparatus wirelessly connected to a first apparatus, a signal containing a signal from the first apparatus;
calculating a receiving weight matrix based on the received signal and a channel matrix that is for communication between the first apparatus and the second apparatus; and
multiplying the received signal by the receiving weight matrix.

2. The wireless communication method according to claim 1, wherein
the receiving weight matrix contains eigenvectors of a first matrix in which noise inside the second apparatus has been added to the diagonal components of the covariance matrix of an interference channel for an interference signal,
the eigenvectors of the first matrix contained in the receiving weight matrix are the eigenvectors corresponding to a given number of eigenvalues with the smallest values from the eigenvalues of the first matrix, and
the given number is the number of data streams in the first apparatus.

3. The wireless communication method according to claim 1, wherein
the receiving weight matrix contains eigenvectors of the covariance matrix of a first vector,
the eigenvectors of the covariance matrix of the first vector contained in the receiving weight matrix are the eigenvectors corresponding to a given number of eigenvalues with the smallest values from the eigenvalues of the covariance matrix of the first vector,
the given number is the number of data streams in the first apparatus, and
the first vector is calculated based on the signal received at the second apparatus, a channel matrix for communication between the first apparatus and the second apparatus, and a reference signal transmitted from the first apparatus.

4. The wireless communication method according to claim 3, wherein
the first vector z is expressed as
z=r−H₁s₁
where r is the signal received at the second apparatus, H₁ is the channel matrix for communication between the first apparatus and the second apparatus, and s₁ is the reference signal transmitted from the first apparatus.

5. A relay node wirelessly connected to user equipment, comprising:
a receiver configured to receive a signal containing a signal from the user equipment; and
a processor configured
to calculate a receiving weight matrix based on the signal received by the receiver and a channel matrix for communication between the user equipment and the relay node, and
to multiply the signal received by the receiver using the receiving weight matrix.

6. The relay node according to claim 5, wherein
the receiving weight matrix contains eigenvectors of a first matrix in which noise inside the relay node has been added to the diagonal components of the covariance matrix of an interference channel for an interference signal,
the eigenvectors of the first matrix contained in the receiving weight matrix are the eigenvectors corresponding to a given number of eigenvalues with the smallest values from the eigenvalues of the first matrix, and
the given number is the number of data streams in the user equipment.

7. The relay node according to claim 5, wherein
the receiving weight matrix contains eigenvectors of the covariance matrix of a first vector,
the eigenvectors of the covariance matrix of the first vector contained in the receiving weight matrix are the eigenvectors corresponding to a given number of eigenvalues with the smallest values from the eigenvalues of the covariance matrix of the first vector,
the given number is the number of data streams in the user equipment, and
the first vector is calculated based on the signal received by the receiver, a channel matrix that is for communication between the user equipment and the relay node, and a reference signal transmitted from the user equipment.

8. The relay node according to claim 7, wherein
the first vector z is expressed as
z=r−H₁s₁
where r is the signal received by the receiver, H₁ is the channel matrix for communication between the user equipment and the relay node, and s₁ is the reference signal transmitted from the user equipment.

9. A base station wirelessly connected to user equipment, comprising:
a receiver configured to receive a signal containing a signal from the user equipment; and
a processor configured
to calculate a receiving weight matrix based on the signal received by the receiver and a channel matrix that is for communication between the user equipment and the base station, and
to multiply the signal received by the receiver using the receiving weight matrix.

10. The base station according to claim 9, wherein
the receiving weight matrix contains eigenvectors of a first matrix in which noise inside the base station has been added to the diagonal components of the covariance matrix of an interference channel for an interference signal,
the eigenvectors of the first matrix contained in the receiving weight matrix are the eigenvectors corresponding to a given number of eigenvalues with the smallest values from the eigenvalues of the first matrix, and
the given number is the number of data streams in the user equipment.

11. The base station according to claim 9, wherein
the receiving weight matrix contains eigenvectors of the covariance matrix of a first vector,
the eigenvectors of the covariance matrix of the first vector contained in the receiving weight matrix are the eigenvectors corresponding to a given number of eigenvalues with the smallest values from the eigenvalues of the covariance matrix of the first vector,
the given number is the number of data streams in the user equipment, and
the first vector is calculated based on the signal received by the receiver, a channel matrix for communication between the user equipment and the base station, and a reference signal transmitted from the user equipment.

12. The base station according to claim 11, wherein
the first vector z is expressed as
z=r−H₁s₁
where r is the signal received by the receiver, H₁ is the channel matrix between the user equipment and the base station, and s₁ is the reference signal transmitted from the user equipment.
